(19) United States
(12) Patent Application Publication
(10) Pub. No.: US 2025/0229573 A1
(43) Pub. Date: Jul. 17, 2025

(54) Spring Mechanism for Rigid Casters and Method of Converting Rigid Casters Into Spring Loaded Casters

(71) Applicant: Davaus, LLC, Hoagland, IN (US)

(72) Inventors: Austin D. Ehle, Fort Wayne, IN (US); David J. Hockemeyer, Hoagland, IN (US); Treg Shidler, Clay City, IN (US); Andrew Fuelling, Decatur, IN (US); John D. Nance, Bedminster, NJ (US); George Pappas, Fort Wayne, IN (US)

(73) Assignee: Davaus, LLC, Hoagland, IN (US)

(21) Appl. No.: 19/022,154

(22) Filed: Jan. 15, 2025

Related U.S. Application Data
(60) Provisional application No. 63/621,357, filed on Jan. 16, 2024.

(51) Int. Cl. B60B 33/00; B60B 33/04; B60B 33/06

(52) U.S. Cl. CPC B60B 33/0057; B60B 33/0068; B60B 33/0076; B60B 33/045; B60B 33/066; B60B 33/0005; B60B 33/0039; B60B 2900/551

(57) ABSTRACT

A suspension mechanism for installation on a rigid caster, one on each caster fork leg, includes a pivot arm and an abutment arm pivotally secured to the fork leg, with the abutment arm between the pivot arm and the fork leg. An elastically compressible spring is sandwiched between the pivot arm and the abutment arm. The wheel axle is coupled to and between the pivot arms. Impacts experienced by the wheel are cushioned by the spring as they are transferred to the abutment arm fork leg. The mechanism is installed by uncoupling the wheel axle from the fork legs, pivotably securing the pivot and abutment arms to the fork legs with the abutment arms extending between the pivot arms and the fork legs, sandwiching a spring between the pivot arms and the abutment arms; and, coupling the wheel axle to the pivot arms for rotatably securing the wheel thereto.

### CROSS REFERENCE TO RELATED APPLICATION

This application claims benefit under 35 U.S.C. 119 (e) to provisional application Ser. No. 63/621,357 filed on Jan. 16, 2024, the disclosure of which is hereby incorporated by reference.

### BACKGROUND OF THE INVENTION

### 1. Field of the Invention

The present invention relates to casters and caster assemblies used on land vehicles such as zero turn mowers. More particularly, the present invention is directed to suspension spring mechanisms for installation on rigid casters and methods of converting rigid casters into spring loaded casters.

### 2. Background

Many land vehicles, and particularly agricultural land vehicles, such as, for example, tractors, mowers, trailers, carts, etc., utilize casters also known as “caster wheels” and “caster assemblies”. For example, zero-turn tractors/mowers often include a pair of swivel type casters which are pivotable about a vertical axis for enabling smooth turning/steering thereof. Oftentimes, however, the casters thereof are rigid. That is, they often do not include any suspension or spring means for absorbing and/or cushioning impacts/forces resulting from the vehicle traversing over bumps, divots, and otherwise rough or uneven terrain, and so the rider of the vehicle is subjected to a “rough” or “bumpy” ride, and the vibrations and/or jolting of the vehicle can cause wear and tear thereto.

Accordingly, a need exists for a suspension mechanism for installing on a rigid caster and a method of converting a rigid caster into a spring loaded caster.

### SUMMARY OF THE INVENTION

In one form thereof, the present invention is directed to a suspension mechanism adapted to be installed on a caster comprising a fork and a wheel, wherein the fork includes a pair or fork legs and the wheel is rotatably mounted on an axle coupled to the fork legs, wherein a suspension mechanism is installed between each of the fork legs and the wheel axle and each suspension mechanism includes: a pivot arm pivotally secured to and projecting from a fork leg, and coupled to the wheel axle; an abutment arm pivotally secured to and projecting from the fork leg, and abutting the fork leg; and, a spring between the pivot arm and the abutment arm which cushions impact forces experienced by the wheel and axle as they are transferred to the abutment arm the fork leg.

Preferably, the suspension mechanism pivot arm and abutment arm pivot about a common axis. Also, the pivot arm and abutment arm are pivotally secured to the fork leg at the location whereat the axle was coupled to the fork leg.

The spring is preferably an elastically compressible spring comprising a hollow elastically compressible polymer member, a hollow cylinder comprising a flexible annular perimeter wall, a solid elastically compressible polymer member, or a coil spring.

Each suspension mechanism can also include a stopper secured to and adapted to retract or extend away from the abutment arm and abut the fork leg whereby the distance between the fork leg and abutment arm is selectively adjustable. The stopper can include a semispherical head or a fork leg receiving channel abutting the fork leg.

Preferably, the pivot arm includes a spring engaging shelf projecting therefrom and located between the pivot arm to fork leg pivotal connection and the pivot arm to wheel axle coupling, and the abutment arm includes a spring wall projecting therefrom, and the spring is sandwiched between the pivot arm spring engaging shelf and the abutment arm spring wall.

Also preferably, the pivot arms and abutment arms are pivotally secured to the fork legs outside of a gap defined between the fork legs. The pivot arm and abutment arm can be pivotally secured to the fork leg at the location whereat the axle was coupled to the fork leg on a suspension shaft, and wherein the pivot and abutment arms pivot independently from, and slide past, each other like scissor blades.

The pivot arms can also include a plurality of wheel axle bores spaced at different distances from the pivot arm to fork leg pivotal connection, whereby the wheel axle can be coupled to the pivot arm at different distances from the pivot arm to fork pivotal connection.

The caster can be pivotally secured to a zero turn mower and adapted to pivot about a vertical axis.

The pivot arm can include a pivot stop tab adapted to engage the abutment arm and limit the rotational travel of the pivot arm, and the abutment arm can include a pivot stop tab adapted to engage the fork leg and limit the rotational travel of the abutment arm. A second spring can be nested within the spring located between the pivot arm and the abutment arm.

In another form thereof, the present invention is directed to a caster assembly including: a fork; a wheel; and, a suspension mechanism. The suspension mechanism includes: a pivot arm pivotally secured to the fork and projecting therefrom; wherein the wheel is rotatably secured to the pivot arm; an abutment arm pivotally secured to the fork and projecting therefrom, and abutting the fork; a spring between the pivot arm and the abutment arm; and, wherein impact forces experienced by the wheel are cushioned by the spring as they transferred to the abutment arm and to the fork.

The pivot arm and abutment arm preferably pivot about a common axis. The spring is preferably an elastically compressible spring comprising a hollow elastically compressible polymer member, a hollow cylinder comprising a flexible annular perimeter wall, a solid elastically compressible polymer member, or a coil spring. A stopper is preferably provide and is secured to and adapted to retract or extend away from the abutment arm and abut the fork whereby the distance between the fork and abutment arm is selectively adjustable. The fork can include a fork leg and the stopper can include a semispherical head or a fork leg receiving channel abutting the fork leg.

Preferably, the pivot arm includes a spring engaging shelf projecting therefrom and located between the pivot arm to fork leg pivotal connection and the pivot arm to wheel rotatable securement, and the abutment arm includes a spring wall projecting therefrom, and the spring is sandwiched between the pivot arm spring engaging shelf and the abutment arm spring wall.

Also preferably, the fork includes a pair of fork legs defining a gap therebetween and the pivot arms and abutment arms are pivotally secured to the fork legs outside of the a gap.

The caster can be pivotally secured to a zero turn mower and is adapted to pivot about a vertical axis.

The pivot arm can include a pivot stop tab adapted to engage the abutment arm and limit the rotational travel of the pivot arm, and the abutment arm can include a pivot stop tab adapted to engage the fork and limit the rotational travel of the abutment arm.

A second spring can be provided and nested within the spring located between the pivot arm and the abutment arm.

In yet another form thereof, the present invention is directed to a method of converting a caster which includes a fork and a wheel into a spring loaded caster, wherein the fork includes a pair of fork legs and the wheel is rotatably mounted on an axle coupled to the fork legs, by installing a suspension mechanism between each fork leg and the axle, wherein each suspension mechanism comprises a pivot arm, an abutment arm and an elastically compressible spring. The method includes the steps of: uncoupling the wheel axle from the fork legs; pivotably securing a pivot arm and an abutment arm to each of the fork legs, wherein the abutment arms abut the fork legs; sandwiching an elastically compressible spring between each of the pivot arms and the abutment arms; and, coupling the wheel axle to the pivot arms for rotatably securing the wheel thereto.

Preferably, during the step of pivotably securing, the pivot arm and the abutment arm are secured to each of the fork legs at the location whereat the axle was coupled to the fork leg. Also, each abutment arm includes a stopper secured to and adapted to retract or extend away from the abutment arm towards the fork leg and wherein the method further includes the step of retracting or extending the stopper from the abutment arm and adjusting the distance between the fork leg and the abutment arm. During the step of pivotally securing, the pivot arms and abutment arms are preferably pivotally secured to the fork legs outside of a gap defined between the fork legs.

In yet another form thereof, the present invention is directed to a method of converting a caster which includes a fork and a wheel into a spring loaded caster. The method includes the steps of: uncoupling the wheel from the fork; pivotally securing a pivot arm to the fork, wherein the pivot arm projects away from the fork; pivotally securing an abutment arm to the fork, wherein the abutment arm projects away from the fork and abuts the fork; providing an elastically compressible spring between the pivot arm and the abutment arm; and, rotatably securing the wheel to pivot arm.

Preferably, during the steps of pivotably securing, the pivot arm and the abutment arm are secured to the fork legs at the location whereat the wheel was coupled to the fork. Also, the abutment arm preferably includes a stopper secured to and adapted to retract or extend away from the abutment arm towards the fork and wherein the method further includes the step of retracting or extending the stopper from the abutment arm and adjusting the distance between the fork and the abutment arm.

### BRIEF DESCRIPTION OF THE DRAWINGS

The above-mentioned and other features of this invention and the manner of attaining them will become more apparent, and the invention itself will be better understood by reference to the following description of the embodiments of the invention, taken in conjunction with the accompanying drawings, wherein:

FIG. 1 is a perspective view of a prior art vehicle in the form of a zero-turn mower having swivel/pivotable caster forks mounted to the frame thereof and wheels rotatably mounted to the caster forks;

FIG. 2 is a perspective view of the vehicle shown in FIG. 1 wherein suspension mechanisms have been installed on the pivotable caster forks;

FIG. 3 is a magnified perspective view of one of the pivotable caster forks of the vehicle shown in FIG. 2;

FIG. 4 is a partial exploded perspective view of the pivotable caster fork shown in FIG. 3 wherein the caster fork, vehicle cylindrical fork mount, and the fork pivot shaft bearing cap are shown exploded from one another;

FIG. 5 is a front elevation view of one of the prior art pivotable caster forks shown in FIG. 1 including a wheel rotatably secured thereto and a fork pivot shaft extending vertically upwardly from the fork base;

FIG. 6 is an exploded perspective view of the caster fork and wheel shown in FIG. 5;

FIG. 7 is an exploded top plan view of a caster fork, a pair of suspension mechanisms (one on each side of the caster fork), and a wheel;

FIG. 8 is a partially exploded perspective view of the caster fork, one of the suspension mechanisms, and wheel shown in FIG. 7;

FIG. 9 is a perspective view of the assembled caster fork, suspension mechanisms, and wheel shown in FIGS. 7-8;

FIG. 10 is a perspective view of a caster fork, a single suspension mechanism pivotally secured to one side of the caster fork, a unitary pivot arm pivotally secured to the other side of the caster fork, and a wheel rotatably secured between the suspension mechanism and the unitary pivot arm;

FIGS. 11A-B are perspective views of a wheel supporting pivot arm;

FIGS. 12-13 are side elevation views of a caster fork, a suspension mechanism installed thereon, and wheels mounted on the suspension mechanism, wherein the diameter of the wheel in FIG. 12 is smaller than the diameter of the wheel in FIG. 13;

FIGS. 14A-B are perspective views of a fork engaging abutment arm;

FIG. 15 is another perspective view of the caster fork, suspension mechanisms, and wheel shown in FIGS. 9 and 13;

FIG. 16 is a perspective view of the caster fork, suspension mechanisms, and wheel shown in FIG. 15 wherein the wheel and suspension mechanisms have pivoted downwardly away from the caster fork;

FIG. 17 is a perspective view of the caster fork, suspension mechanisms, and wheel shown in FIG. 15 wherein the wheel and suspension mechanisms have pivoted upwardly towards the caster fork and the spring members have compressed;

FIG. 18 is a side elevation view of the wheel supporting pivot arm shown in FIGS. 11A-B, wherein an ear/stopper receiving depression thereof is shown in greater detail;

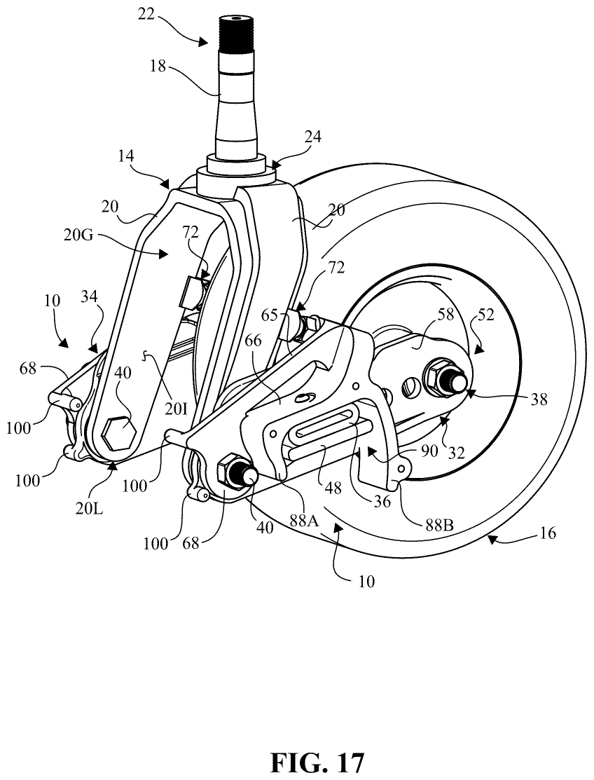

FIG. 19 is a side elevation view of a suspension mechanism, wherein the spring member has been compressed, and an adjustable stopper has entered the ear/stopper receiving depression;

FIG. 20 is a partially exploded perspective view of a caster fork, suspension mechanisms, and wheel, wherein a spring cover plate and fasteners are shown exploded apart from the fork engaging abutment arm;

FIG. 21 is an exploded perspective view of a suspension mechanism having an adjustable stopper with a semispherical abutment surface;

FIG. 22 is a top plan view of a caster fork, suspension mechanisms, and wheel;

FIG. 23 is an exploded perspective view of a suspension mechanism having an adjustable stopper with a fork leg receiving channel;

FIG. 24 is a perspective view of a pair of the suspension mechanisms shown in FIG. 23 installed on a caster fork with a wheel secured between the suspension mechanisms;

FIG. 25A is an exploded perspective view of an adjustable stopper having a head with a fork leg receiving channel and a shaft with a semispherical mount;

FIG. 25B is a top plan view of the adjustable stopper shown in FIG. 25A engaging a leg of a caster fork;

FIG. 26A is a section view of the caster fork and adjustable stopper taken along the line 26-26 shown in FIG. 25B;

FIG. 26B is another section view of the caster fork and adjustable stopper taken along the line 26-26 shown in FIG. 25B, wherein the adjustable stopper has been extended and the stopper head has pivoted about its spherical mount to remain flush with the caster fork leg;

FIG. 27 is a side elevation view of the caster fork, suspension mechanism, and wheel shown in FIGS. 12 and 13 wherein the spring is a coil spring;

FIG. 28 is a side elevation view of the caster fork, suspension mechanism, and wheel shown in FIGS. 12 and 13 wherein the spring is a solid, elastically compressible member;

FIGS. 29 and 30 are side elevation views of the caster fork, suspension mechanism, and wheel shown in FIGS. 12 and 13 wherein the adjustable stoppers have been extended or retracted for increasing or decreasing the ride height of the suspension mechanisms;

FIG. 31 is a side elevation view similar to FIG. 12 and illustrating a second nested spring within a larger hollow cylinder spring;

FIG. 32 is a perspective view of the caster fork, suspension mechanisms, and wheel shown in FIGS. 9 and 13 wherein the suspension mechanisms further include adjustable rotation limiting members;

FIG. 33 is a partially exploded perspective view of a suspension mechanism shown in FIG. 32 wherein the rotation limiting member is shown separated apart from the wheel supporting pivot arm and the fork engaging abutment arm; and,

FIG. 34 is a magnified view of Circled Detail 34 in FIG. 33 showing the interlocking teeth of the rotation limiting member and the fork engaging abutment arm

Corresponding reference characters indicate corresponding parts throughout several views. Although the exemplification set out herein illustrates certain embodiments of the invention, the embodiments disclosed below are not intended to be exhaustive or to be construed as limiting the scope of the invention to the precise form disclosed.

### DETAILED DESCRIPTION OF THE PREFERRED EMBODIMENTS

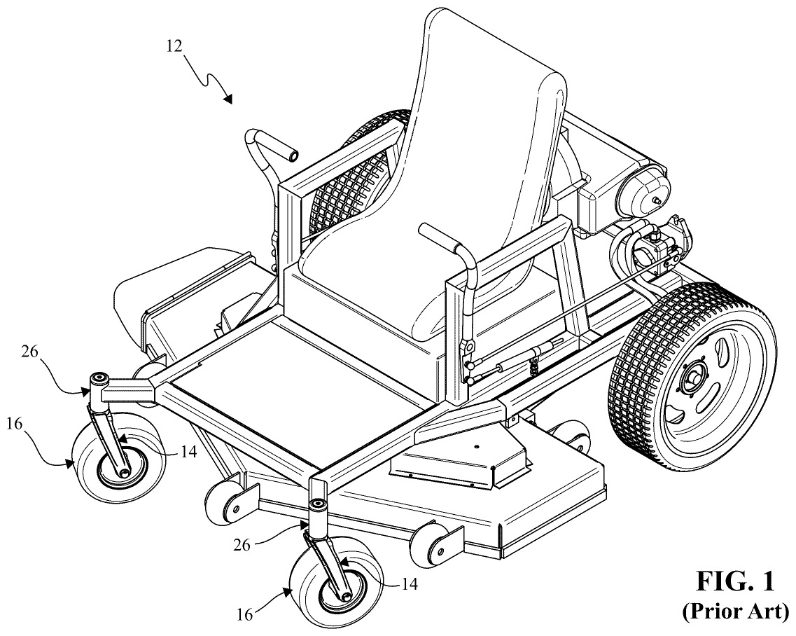

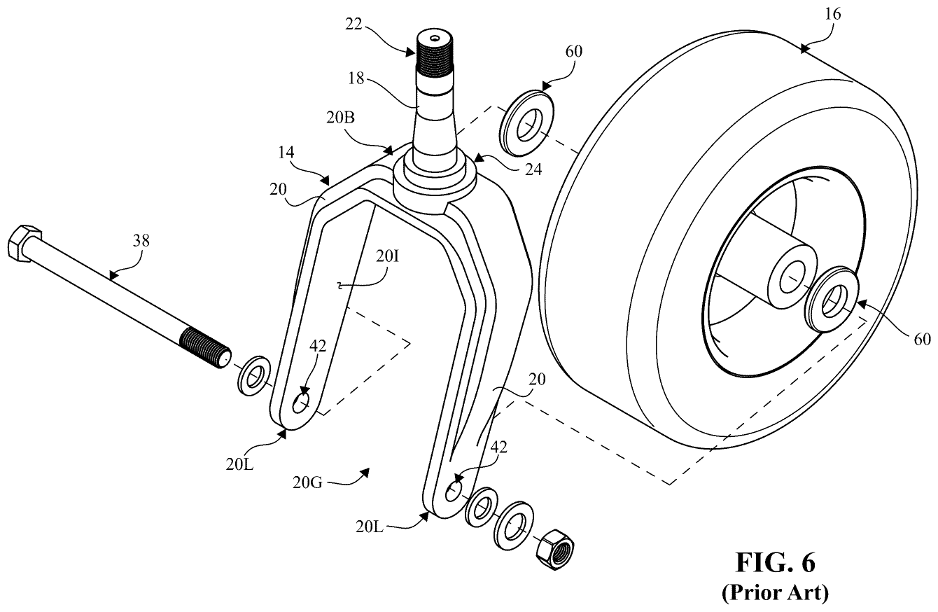

Referring initially to FIGS. 1-9, suspension mechanisms constructed in accordance with the principles of the present invention are shown and generally designated by the numeral 10. The suspension mechanisms 10 are adapted to be installed on rigid casters, also known as “caster assemblies,” which, as shown in FIGS. 1, 5 and 6, comprise a wheel 16 rotatably mounted in a U-shaped bracket commonly referred to as the “yoke” or the “fork” 14. The U-shaped fork 14 includes a pair of fork legs 20 extending downwardly from a fork base 20B. The wheels 16 are rotatably mounted on an axle 38 which extends between and is coupled to each of the fork legs 20. Casters can be of the “swivel” type, as shown in FIGS. 1, 5 and 6, wherein the fork 14 and wheel 16 are adapted to swivel/rotate 360° about a vertical axis, or of the “non-rotatable” type (not shown) wherein the fork 14 is fixed/does rotate about a vertical axis. As more fully described hereinbelow, the suspension mechanisms 10 are adapted to be installed on casters by pivotally securing one end the mechanism on a fork leg 20 and rotatably securing the wheel axle 38 to the other end of the mechanism and to thereby convert the caster into a “spring loaded caster” whereby impacts/shocks and vibrations experienced by the wheel, such as when traversing over rough or uneven terrain, are absorbed so that the caster fork 14 along with the land vehicle being supported by the caster is cushioned.

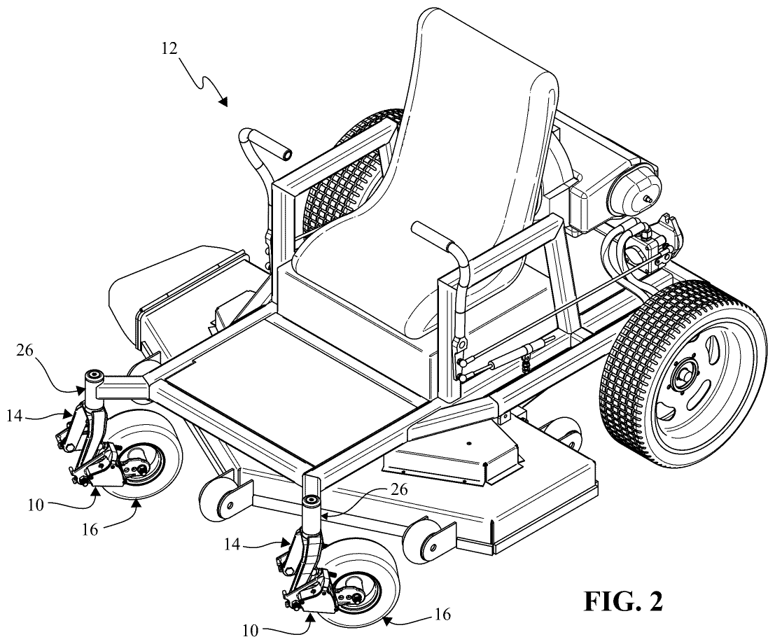

The suspension mechanisms 10 can be installed on casters which are used on various types of land vehicles, such as, for example, zero-turn tractors/mowers, trailers, carts, and other utility and agricultural vehicles. However, they are particularly useful when installed on casters of land vehicles which often traverse over rough, bumpy, and uneven terrain such as, for example, zero-turn mowers 12. As depicted in FIG. 1, zero-turn mowers comprise a pair of swivel type casters which are adapted to pivot about a vertical axis. The suspension mechanisms 10 can be installed on both of the zero-turn mower swivel casters as depicted in FIG. 2, wherein the suspension mechanisms 10 are pivotably secured to the swivel caster forks 14 and wheels 16 are rotatably secured to the suspension mechanisms 10.

As the wheels 16 of the zero-turn mower 12 roll over bumps, divots, and otherwise rough or uneven terrain, the wheels 16 experience vertically upward impacts/forces which are cushioned by the suspension mechanisms 10 before they are transferred to the caster forks 14 and the zero-turn mower 12. As will be discussed in greater detail hereinbelow, the suspension mechanisms 10 are adapted to act as dampers to absorb energy from sudden impacts/forces experienced by the wheels 16 and thereby reduce vibrations and jolts/impacts transferred to the zero-turn mower 12.

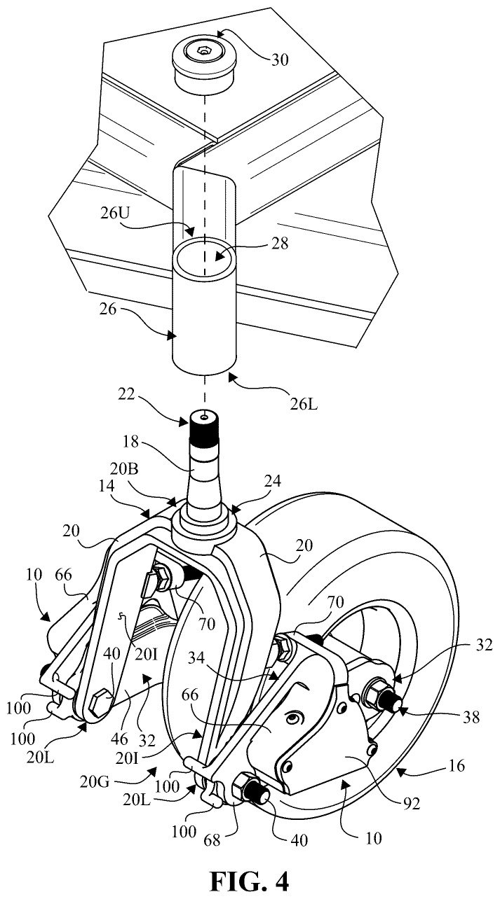

As best seen in FIGS. 1, 5 and 6, the swivel caster forks 14 of the zero-turn mower 12 can comprise an upper pivot shaft 18 extending upwardly from the fork base 20B. The upper pivot shafts 18 comprise a threaded upper terminal end 22 and a lower annular abutment ledge 24. The upper pivot shafts 18 are adapted to be rotatably secured to the zero turn mower 12. More particularly, the zero turn mower 12 can comprise one or more cylindrical fork mounts 26 having vertical pivot shaft receiving bores 28 sized to receive the upper pivot shaft 18 therein. As shown in FIG. 4, a caster fork 14 can be secured to a cylindrical fork mount 26 by inserting the upper pivot shaft 18 thereof through the fork mount pivot shaft receiving bore 28 until the lower annular abutment ledge 24 engages a lower end 26L of the cylindrical fork mount 26. A bearing cap 30 can be threaded onto the pivot shaft threaded upper terminal end 22 and rotatably tightened against an upper end 26U of the cylindrical fork mount 26. As should now be appreciated, the bearing cap 30 and the lower annular abutment ledge 24 sandwich the fork mount 26 for pivotally securing the upper pivot shaft 18, and, hence, the caster fork 14, thereto.

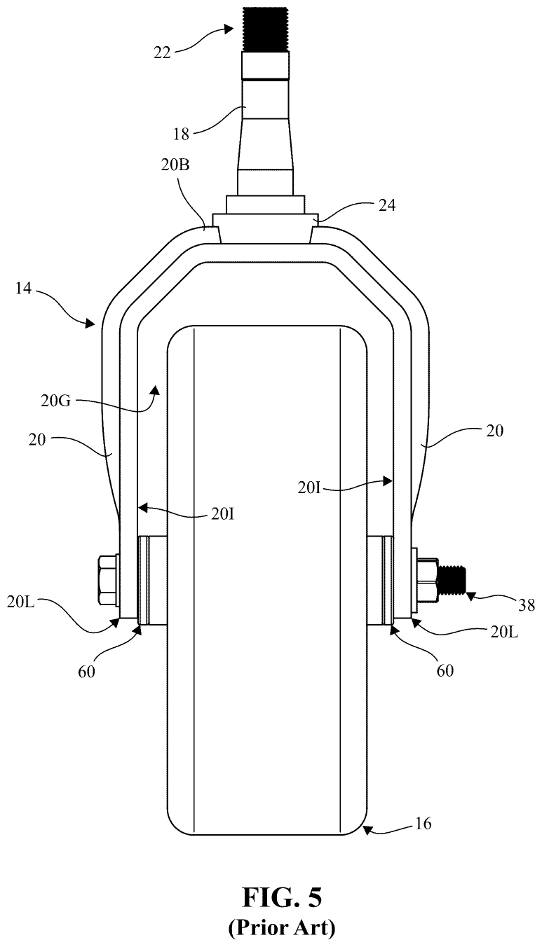

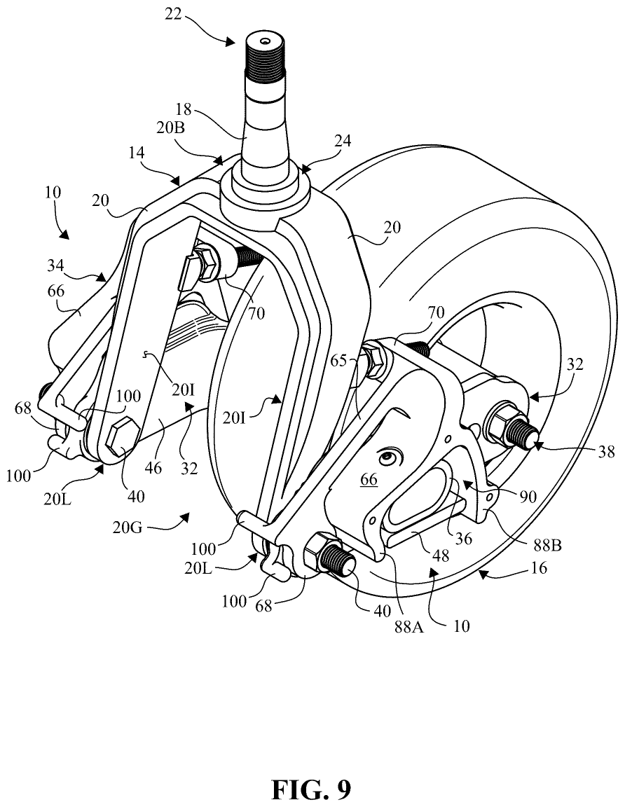

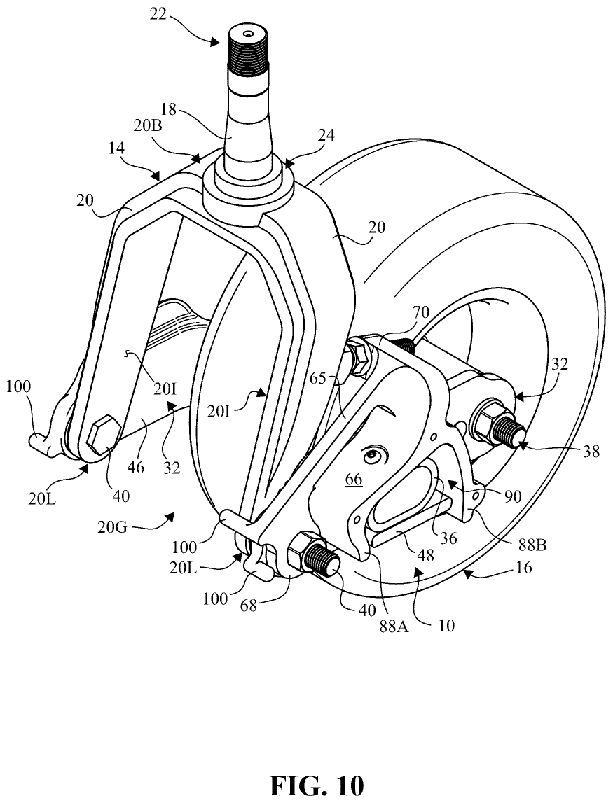

Referring now to FIGS. 5, 6, and 9, the fork legs 20 extend vertically downwardly from the fork base 20B and comprise lower terminal ends 20L whereat the suspension mechanisms 10 are preferably pivotally secured. The caster fork legs 20 are horizontally spaced apart from each other and, together with the fork base 20B, form a U-shaped bracket whereby the wheel 16 can be mounted within a gap 20G between the legs 20. Preferably, as shown in FIG. 9, a suspension mechanism 10 can be pivotably secured to each of the caster fork legs 20, and the wheel axle 38 can be mounted between the pair of suspension mechanisms 10, whereby the wheel 16 is supported in a cantilevered manner and is aligned with and can pivot in and out of the gap 20G. Alternatively, as shown in FIG. 10, a single suspension mechanism 10 can be pivotably secured to one of the fork legs 20, a unitary pivot arm 32 can be pivotally secured to the other fork leg 20, and the wheel axle 38 can be mounted between the suspension mechanism 10 and the unitary pivot arm 32, whereby the wheel 16 is similarly supported in a cantilevered manner and can pivot in and out of the fork gap 20G.

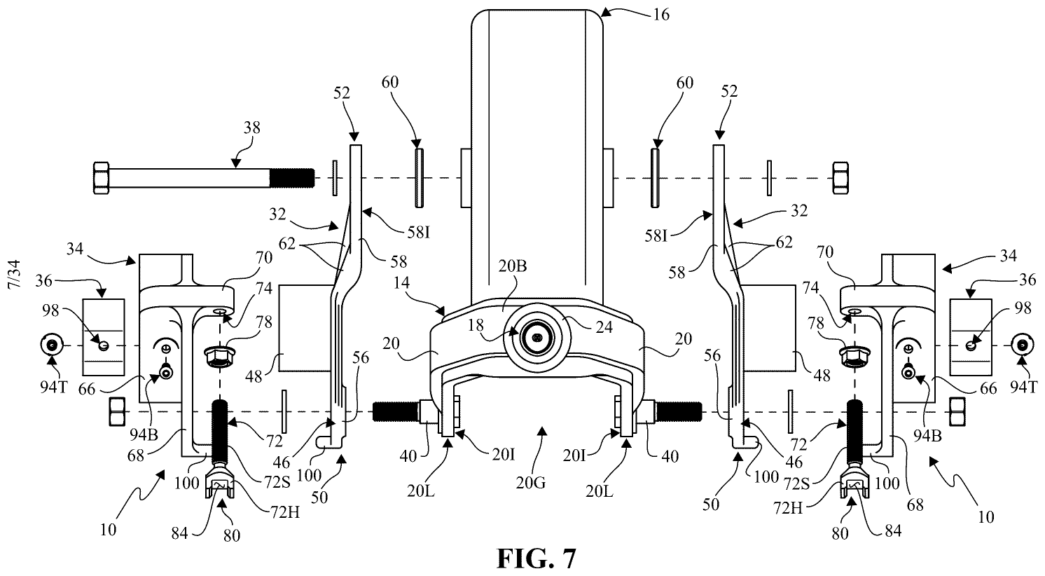

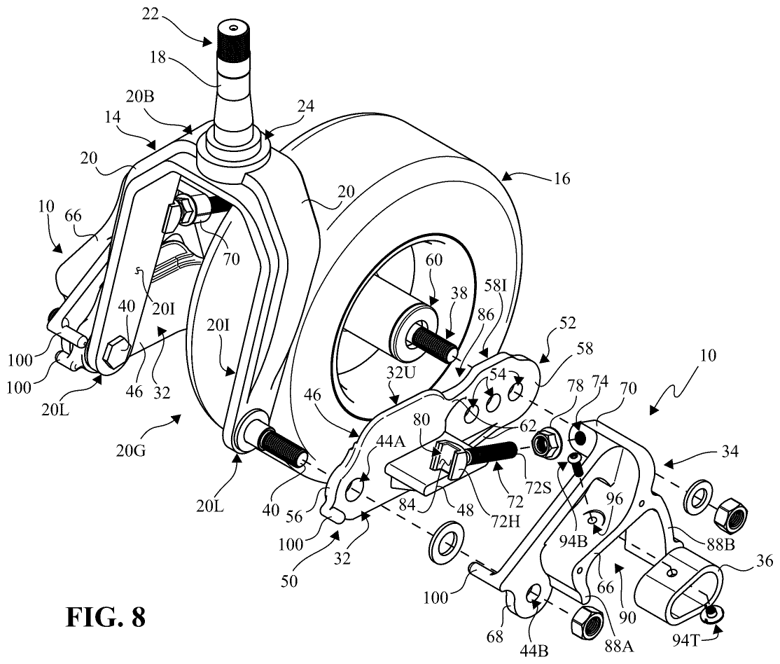

As shown in FIGS. 7 and 8, the suspension mechanisms 10 can comprise a wheel carrying pivot arm 32, a fork engaging abutment arm 34, and a spring/cushion 36. The pivot and abutment arms 32, 34 can be pivotably secured to the fork leg lower terminal ends 20L. Preferably, the pivot arms 32 extend generally horizontally away from the generally vertical fork legs 20 and the abutment arms 34 extend over the pivot arms 32 and between the pivot arms 32 and the fork legs 20. The springs 36 are sandwiched between, and are preferably secured to one or both of, the pivot arms 32 and the abutment arms 34. The wheels 16 can be rotatably mounted on wheel axles 38 which are secured to and between the pivot arms 32, as best illustrated in FIG. 7. The abutment arms 34 are adapted to abut the fork leg 20 to which they are pivotally secured.

Preferably, as best seen in FIG. 8, the pivot and abutment arms 32, 34 can be pivotably secured to the fork leg lower terminal ends 20L, to the fork wheel axle bores 42 whereat the wheel axle 38 was secured to the fork leg, with a suspension pivot shaft 40. More particularly, the fork leg lower terminal ends 20L can include fork wheel axle bores 42 and the pivot and abutment arms 32, 34 can include pivot and abutment arm mounting bores 44a, 44b respectively. The suspension pivot shaft 40 can be received through the fork leg wheel axle bore 42 and a pivot arm mounting bore 44a and/or an abutment arm mounting bore 44b for pivotably securing the pivot arm 32 and/or the abutment arm 34 to the fork leg 20. Preferably, the pivot and abutment arms 32, 34 of a suspension mechanism 10 are mounted on the same suspension pivot shaft 40 so as to rotate about the same axis of rotation, whereby the pivot and abutment arms 32, 34 are independently pivotable and can slide past each other like the blades of a pair of scissors.

Preferably, the suspension mechanisms 10 can be installed on a caster of a land vehicle by: (i) uncoupling the wheel axle 38 from the fork legs 20 of the caster fork 14; (ii) pivotably securing a pivot arm 32 and an abutment arm 34 to the lower terminal ends 20L of each fork leg 20 (to the fork leg wheel axle bores 42) with the abutment arms 34 extending over the pivot arms 32 and between the pivot arms 32 and the fork legs 20; (iii) providing and sandwiching springs 36 between the pivot and abutment arms 32, 34; and (iv) coupling the wheel axle 38 to the pivot arms 32 for rotatably securing the wheel 16 thereto.

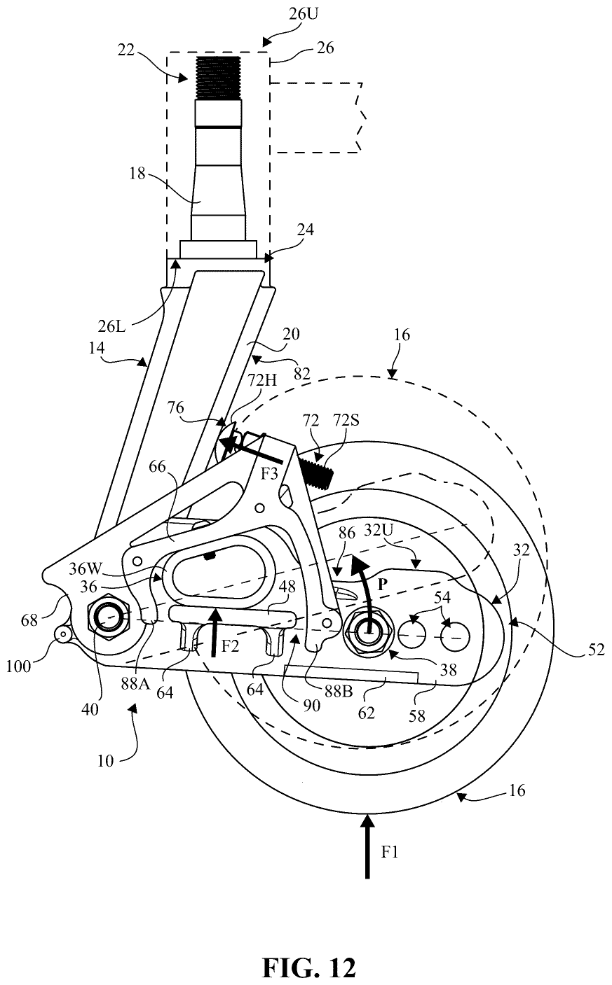

In operation, the springs 36 are sandwiched between the pivot and abutment arms 32, 34 and act as springs/dampers for absorbing energy from sudden impacts/jolts to the wheels 16 and thereby cushioning and reducing vibrations and jolting from being transferred to the land vehicle such as a zero turn mower 12. More particularly, as shown in FIG. 12, vertically upward impacts/forces F1 experienced by the wheels 16 are transferred through the wheel axle 38 and the pivot arms 32 to the springs 36 as impacts/forces F2. The impacts/forces F2 are then transferred through the springs 36 and the abutment arms 34 to the caster fork 14 as cushioned impacts/forces F3. Accordingly, the impact/forces experienced by the cylindrical fork mounts 26, and, hence, the land vehicle/zero turn mower 12 are also cushioned. That is, as the wheels 16 experience jolts/impacts, the springs 36 are compressed by the impacts/forces F2, thereby absorbing energy therefrom and dampening the transfer of energy through the abutment arms 34 and the caster fork 14 to the vehicle/zero turn mower 12.

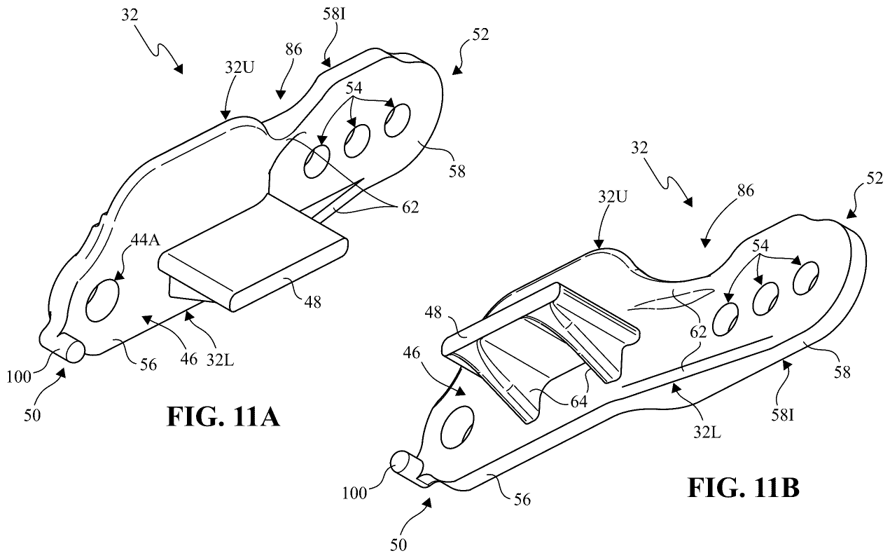

Turning now to FIGS. 11A-B, the wheel carrying pivot arms 32 can comprise a vertical pivot arm wall 46 and a lower spring engaging shelf 48 extending perpendicularly therefrom. The pivot arm wall 46 can include a pivot arm mounting end 50 whereat the pivot arm mounting bore 44a is located and an opposite wheel mounting end 52 having one or more wheel axle bores 54. The wheel axle bores 54 are adapted to receive the wheel axle 38 for securing the wheel 16 to the pivot arm 32. Preferably, the lower spring engaging shelf 48 is located between the pivot arm mounting bore 44a and the wheel axle bores 54.

Preferably, the pivot arm walls 46 include a plurality of wheel axle bores 54 whereby the wheels 16 can be selectively mounted closer or further from the pivot arm mounting end 50, and, hence, the fork legs 20. Allowing the wheels 16 to be selectively mounted closer or further from the fork legs 20 can serve several purposes. In one aspect, the plurality of wheel axle bores 54 spaced at different radial distances from the suspension pivot shaft 40 can allow the suspension mechanisms 10 to accommodate different wheel sizes. More particularly, as shown in FIG. 13, larger wheels 16 can be mounted further from the fork legs 20 to prevent the wheels 16 from rubbing against the caster fork 14 when the suspension mechanisms 10 are compressed and the wheels 16 pivot about the suspension pivot shaft 40, as indicated by arrow P, upwardly and into the fork leg gap 20G.

In another aspect, as shown in FIGS. 12 and 13, by selectively mounting the wheels 16 closer or further from the fork legs 20, an operator can selectively adjust the arcuate travel distance of the wheels 16 as the suspension mechanisms 10 compress. For example, by mounting the wheels 16 further from the fork legs 20, the wheels 16 travel a greater arcuate distance before the springs 36 are fully compressed.

Additionally, by selectively mounting the wheels 16 closer or further from fork legs 20, an operator can selectively adjust the stiffness of the suspension mechanisms 11. More particularly, the pivot arms 32 act like levers pivoting about the suspension pivot shafts 40. By increasing the distance between the wheels 16 and the fork legs 20, the length of the lever correspondingly increases, thereby increasing the impact/force F2 transferred to the springs 36. Accordingly, for a given impact/force F1, the springs 36 compress progressively more as the wheels 16 are mounted further from fork legs 20, and the stiffness of the suspension mechanisms 10 will correspondingly be reduce.

Turning to FIGS. 11A-B, the pivot arms 32 are preferably secured to the fork legs 20 outside of the fork leg gap 20G. Yet more preferably, the pivot arm walls 46 further comprise a mounting portion 56 adjacent the pivot arm mounting end 50 and an offset portion 58 adjacent the wheel mounting end 52. The mounting portion 56 is adapted to abut the fork leg 20 and the offset portion 58 is offset from the mounting portion 56 towards the fork leg gap 20G. Preferably, the offset portion 58 is offset from the mounting portion 56 whereby an interior surface 581 of the offset portion 58 is coplanar with an interior side surface 201 of the fork legs 20.

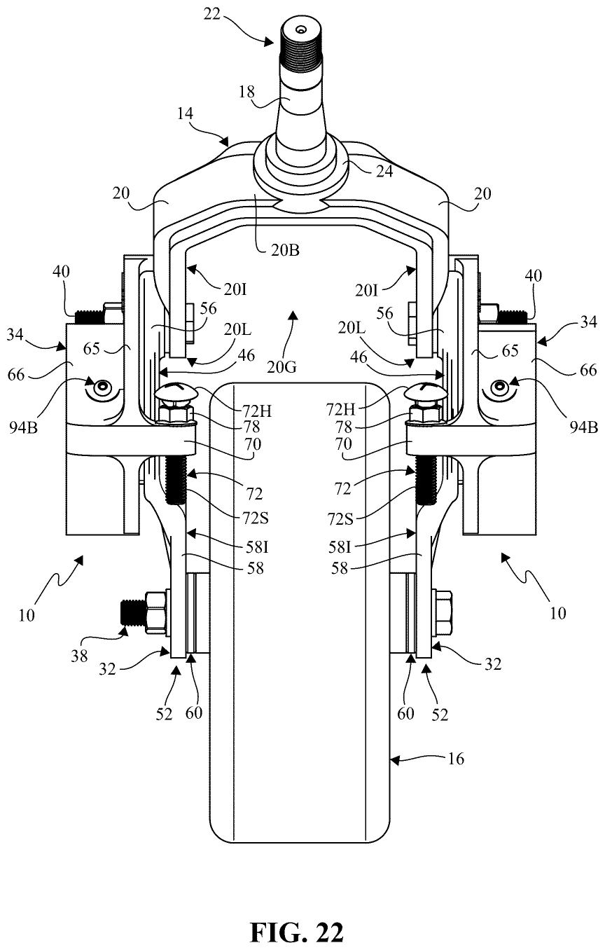

As best seen in FIG. 5, prior to installation of the suspension mechanisms 10, the wheels 16 are rotatably mounted within the gap G between the fork legs 20 and spacers/shims 60 are provided between the wheels 16 and the fork leg interior side surfaces 201 to prevent the wheels 16 from sliding side-to-side along the wheel axles 38. As best seen in FIG. 22, after installation of the suspension mechanisms 10, the wheels 16 are mounted between the offset portion interior surfaces 581 of a pair of pivot arms 32. In this regard, because the interior surfaces 581 of the offset portions 58 are coplanar with the interior side surfaces 201 of the fork legs 20, the pre-existing wheels 16 of the land vehicle/zero turn mower 12 can be mounted to the pivot arms 32 also using the spacers/shims 60 to prevent side-to-side movement of the wheels 16 and align the wheel 16 in a plane between the fork legs 20 which is the same as when the wheel was mounted in the fork 14 as shown in FIG. 5.

Preferably, one or more gusset walls 62 extend between the mounting portions 56 and the offset portions 58. Yet more preferably, a pair of triangular gusset walls 62 extend between the mounting portions 56 and the offset portions 58 wherein one triangular gusset wall 62 is provided along an upper edge 32U of the pivot arm 32 and the other triangular gusset wall 62 is provided along a lower edge 32L of the pivot arm 32. The gusset walls 62 provide support for, and increase the structural rigidity of, the pivot arms 32 for preventing bending or twisting thereof during operation of the land vehicle/zero turn mower 12.

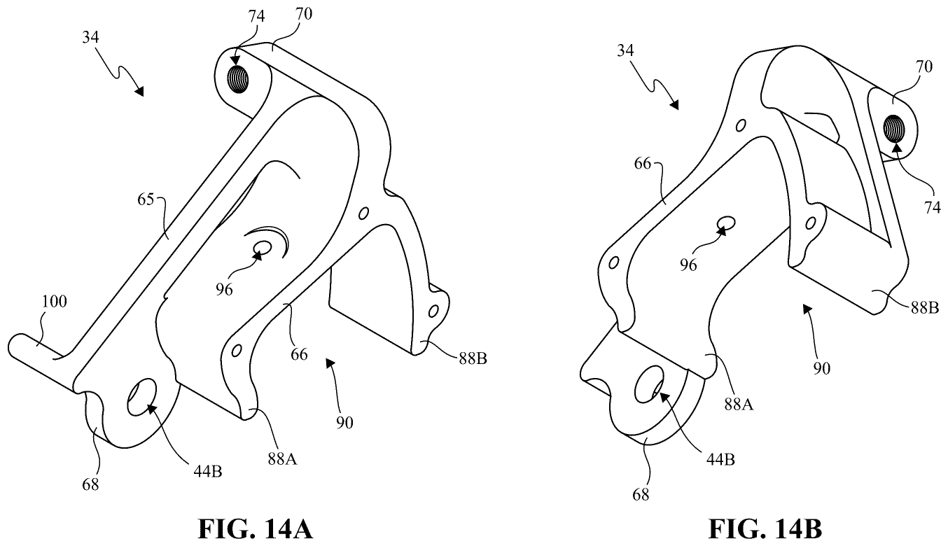

As mentioned above, the pivot arms 32 comprise a lower spring engaging shelf 48 extending perpendicularly from the pivot arm wall 46. The lower spring engaging shelves 48 engage the springs 36 whereby the impacts/forces F2 are transferred to the springs 36. Preferably, the lower spring engaging shelves 48 are located between the pivot arm mounting bores 44a and the wheel axle bores 54 and extend perpendicularly from the pivot arm walls 46 away from the fork leg gap 20G. As shown in FIGS. 15-17 and 19, the lower spring engaging shelves 48 are adapted to engage the springs 36 as the pivot arms 32 pivot upwardly towards the abutment arms 34 and the fork legs 20.

Preferably, the pivot arms 32 can include one or more gusset walls 64 extending between the lower spring engaging shelves 48 and the vertical pivot arm walls 46 to prevent the lower spring engaging shelves 48 from bending or breaking as the impacts/force F2 are transferred to the springs 36. Yet more preferably, the pivot arms 32 include a pair of triangular gusset walls 64 extending between the lower spring engaging shelves 48 and the pivot arm walls 46.

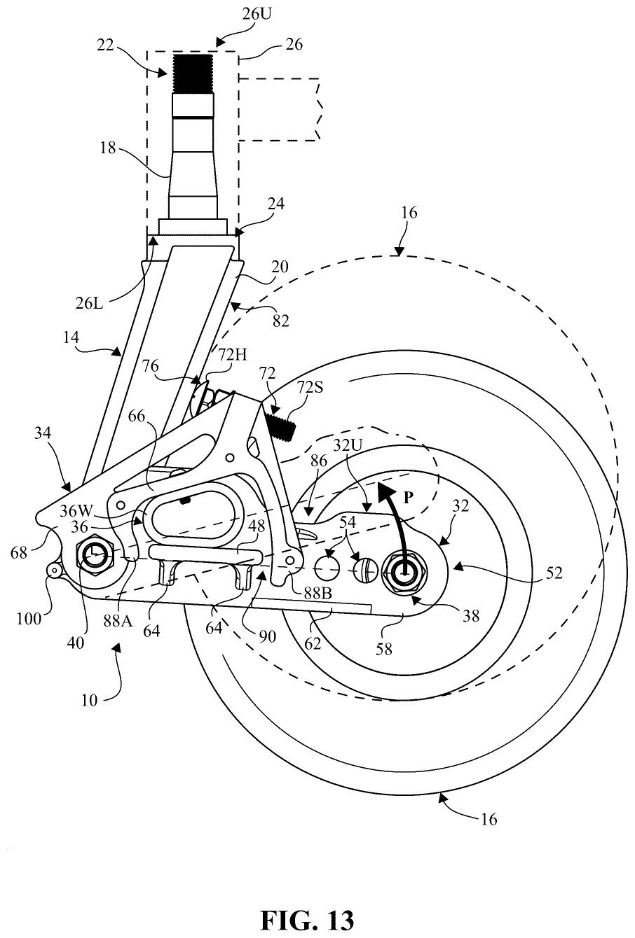

As best seen in FIGS. 14A-B, the fork engaging abutment arms 34 can comprise an upper spring mounting wall 66, an abutment arm mounting tab 68, a fork engaging ear 70 and a stiffening spine portion 65 extending along the upper spring mounting wall 66 and between the abutment arm mounting tab 68 and fork engaging ear 70. The upper spring mounting wall 66 is adapted to extend over the lower spring engaging shelf 48 whereby the spring 36 can be sandwiched therebetween. The abutment arm mounting tab 68 extends from the stiffening spine portion 65 and upper spring mounting wall 66 and includes an abutment arm mounting bore 44B for mounting the abutment arm 34 to a fork leg 20. The fork engaging ear 70 extends from the stiffening spine portion 65 and spring mounting wall 66 preferably opposite the mounting tab 68. The ears 70 are adapted to engage/abut the fork legs 20 to transfer the cushioned impacts/forces F3 to and prevent the abutment arms 34 from pivoting past the caster fork legs 20.

Preferably, the abutment arms 34 can further comprise adjustable stoppers 72 sandwiched between the ears 70 and the fork legs 20. Preferably, as best seen in FIGS. 14A-B, 21, and 23, the ears 70 can include a threaded bore 74 and the adjustable stoppers 72 can comprise a bolt having a head 72H and a threaded shank 72S adapted to threadingly engage the threaded bore 74. In one embodiment, the heads 72H preferably comprise a smooth, semispherical abutment surface 76 adapted to abut the fork legs 20 as shown in FIG. 13.

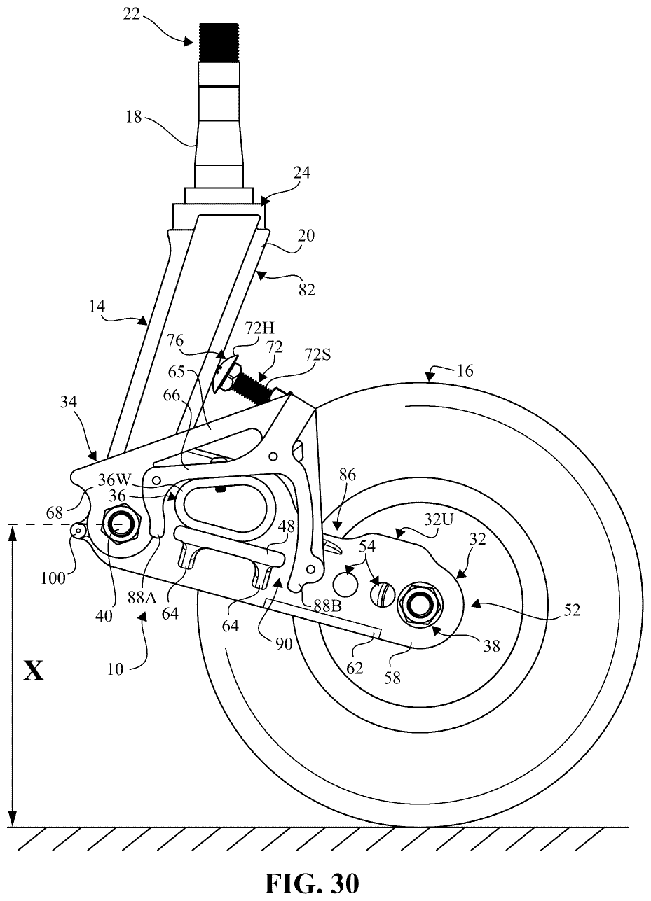

In operation, by threadingly rotating the stopper shank 72S in and out of the ear threaded bore 74, the adjustable stoppers 72 are adapted to allow an operator to selectively increase or decrease the ride height of the caster fork 14. More particularly, when the land vehicle/zero turn mower 12 is parked or is traversing across smooth terrain, the suspension mechanisms 10 will have a natural position whereat they will tend to rest until a force/impact is experienced by the wheels 16. In this natural position, the suspension mechanisms 10 and the wheels 16 support the caster fork 14 a distance above the ground. This distance can be referred to as the “static ride height” of the caster fork 14. As shown in FIGS. 29 and 30, the static ride height of the suspension mechanism 10 can be illustrated as a distance X between the suspension pivot shafts 40 and the ground.

By retracting or extending the adjustable stopper heads 72H towards or away form the ears 70, the resting position of the abutment arms 34, and, hence, the resting position of the suspension mechanisms 10, can be selectively adjusted for thereby increasing or decreasing the distance X between the suspension pivot shafts 40 and the ground. For example, as shown in FIG. 30, by rotatably driving the adjustable stoppers 72 and extending the heads 72 H away from the ears 70, the abutment arms 34, and, hence, the suspension mechanism 10, pivot downwardly away from the fork legs 20, thereby increasing the distance X between the suspension pivot shafts 40 and the ground.

Preferably, the adjustable stopper 72 can further comprise a lock nut 78 threaded onto the shaft 72S between the head 72H and the ear 70. The lock nut 78 is adapted to be rotatingly tightened against the ear 70 for locking the stopper 72 in place when the stopper 72 is in the desired position.

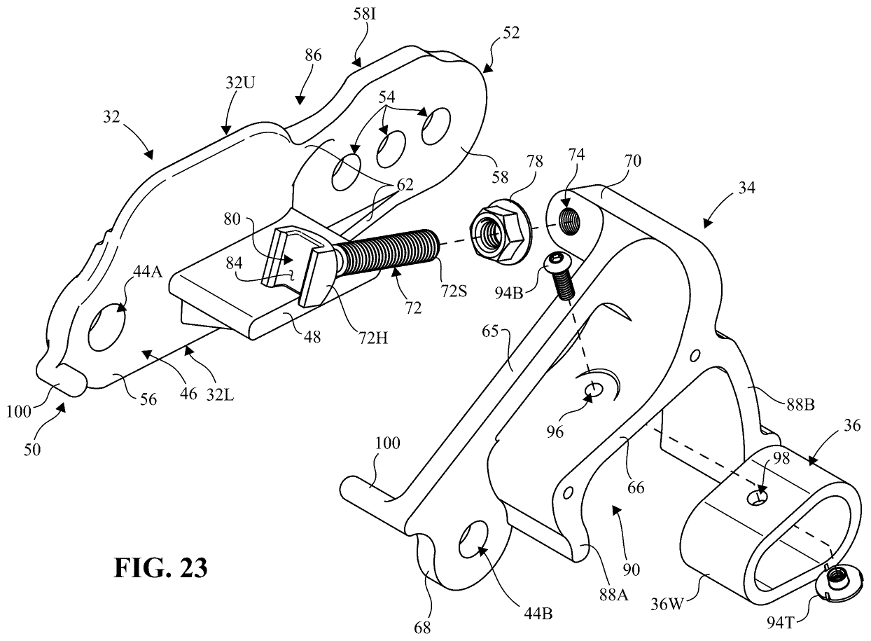

Preferably, as best seen in FIGS. 7, 8, 23, and 25A, the head 72H can include a fork leg receiving channel 80 adapted to receive an abutment edge 82 of the fork legs 20. In this regard, by receiving the abutment edges 82 into the fork leg receiving channels 80, the heads 72H, and, hence, the adjustable stoppers 72, are prevented from deflecting and sliding past the fork legs 20.

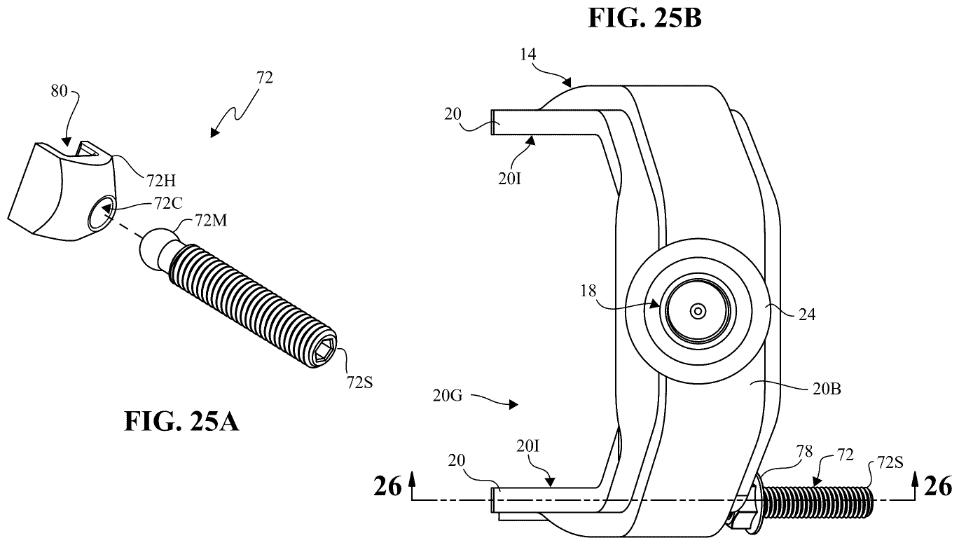

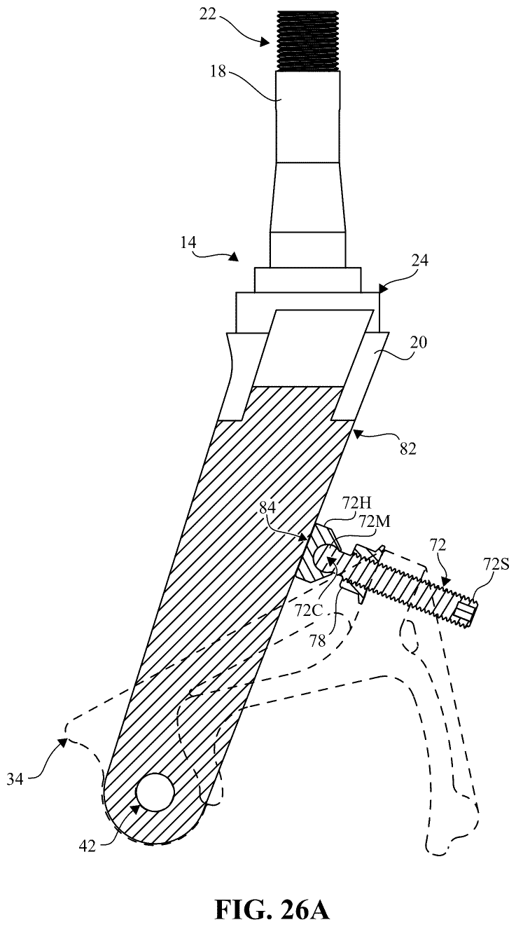

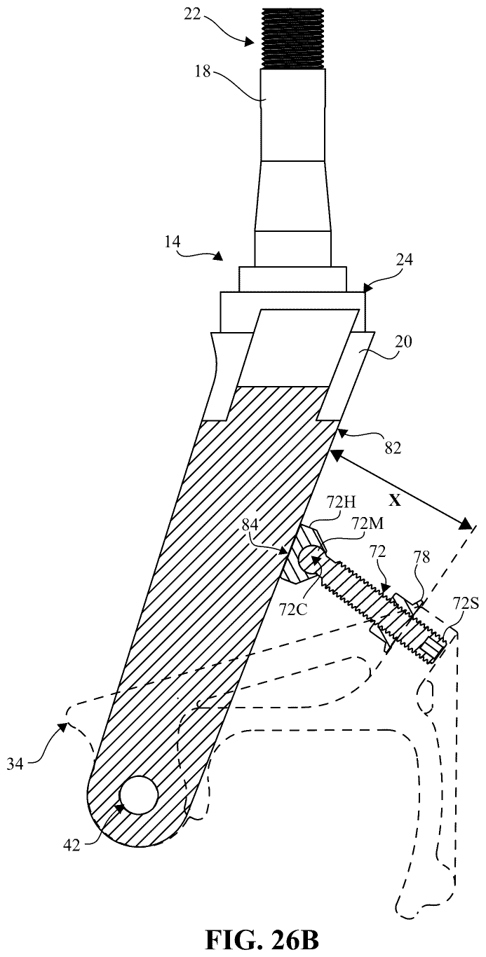

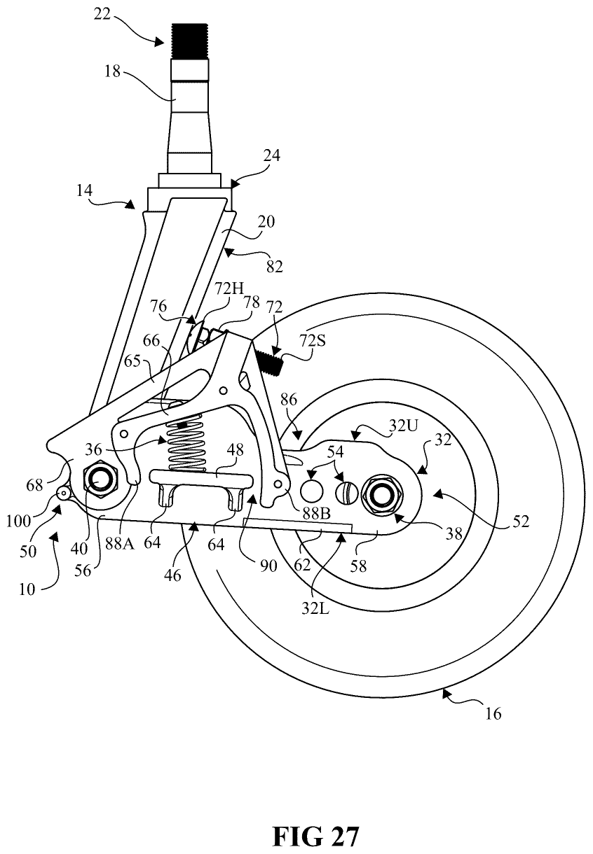

Preferably, as best seen in FIGS. 25A and 26A-B, the heads 72H can be formed separately from the shafts 72S. In this regard, the shafts 72S can comprise a spherical mount 72M at one end thereof, and the heads 72H can comprise a semispherical cavity 72C formed opposite the channel 80 and adapted to receive the spherical mount 72M. Together, the spherical mount 72M and the semispherical cavity 72C form a ball joint whereby the head 72H are pivotable relative to the shafts 72S. In this regard, as the fork leg abutment edge 82 is received into the fork leg receiving channel 80 and engages an abutment surface 84 therein, the heads 72H pivot to ensure the abutment surface 84 sits flush with the abutment edge 82.

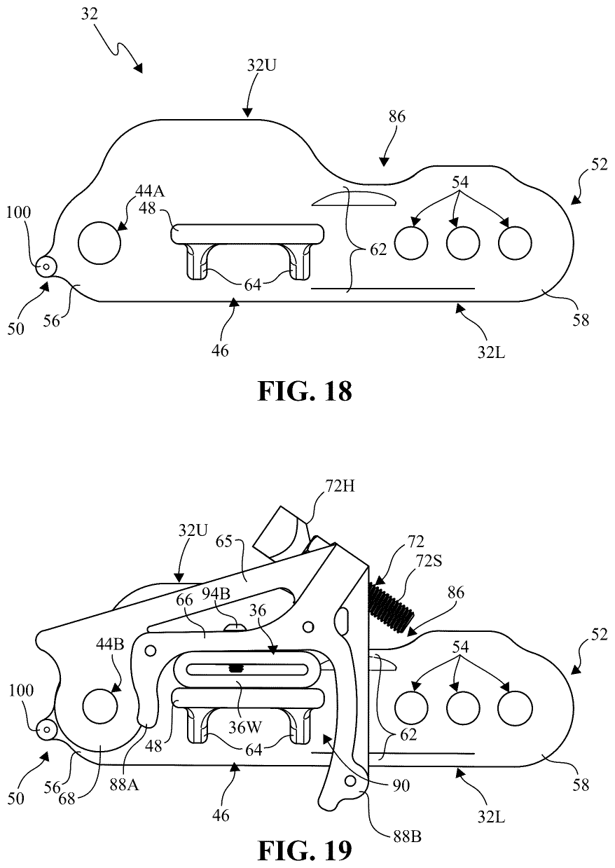

Preferably, the pivot arms 32 include an ear/stopper receiving depression 86 extending into the pivot arm wall 46 along the pivot arm upper edge 32U. As best seen in FIG. 19, when the pivot arms 32 pivot towards the abutment arms 34 and the fork legs 20, the fork engaging ears 70 and/or the adjustable stoppers 72 are received into the ear/stopper receiving depressions 86 for preventing contact between the pivot arms 32 and the ears 70 and/or stoppers 72.

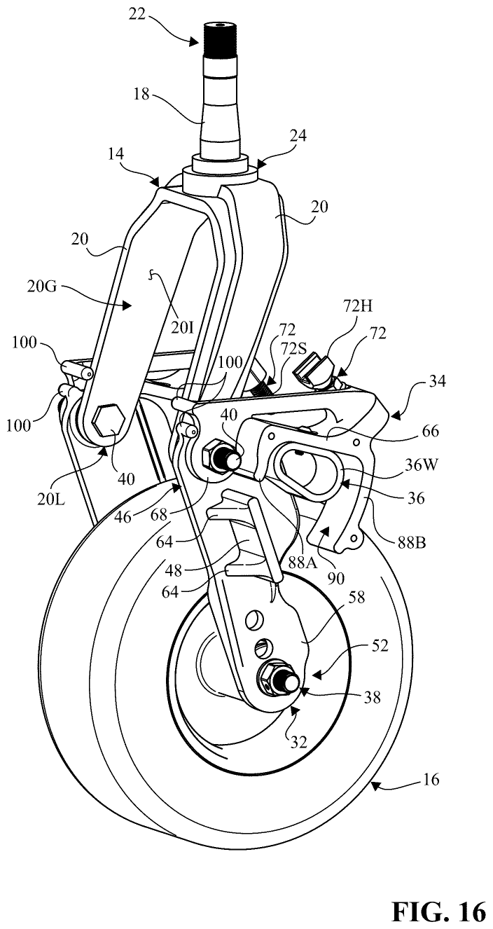

Preferably, the abutment arm 34 further comprises spring enclosing side walls 88a, 88b extending downwardly from the upper spring mounting walls 66 whereby a spring pocket 90 is formed and defined between the walls 66, 88a, 88b. The spring pockets 90 can be adapted to receive the springs 36 therein and are preferably sized such that the lower spring engaging shelves 48 can traverse therethrough, as shown if FIGS. 15 and 17, as the pivot arms 32 pivot towards the abutment arms 34 and the fork legs 20.

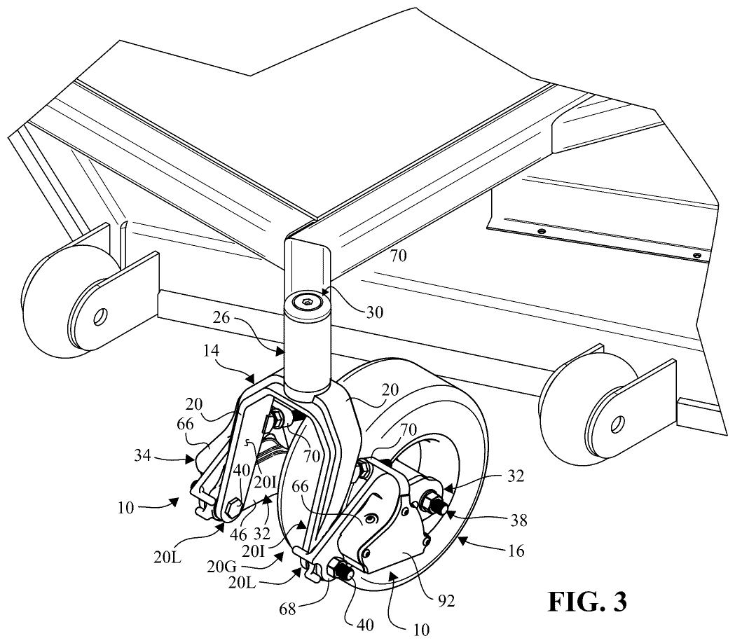

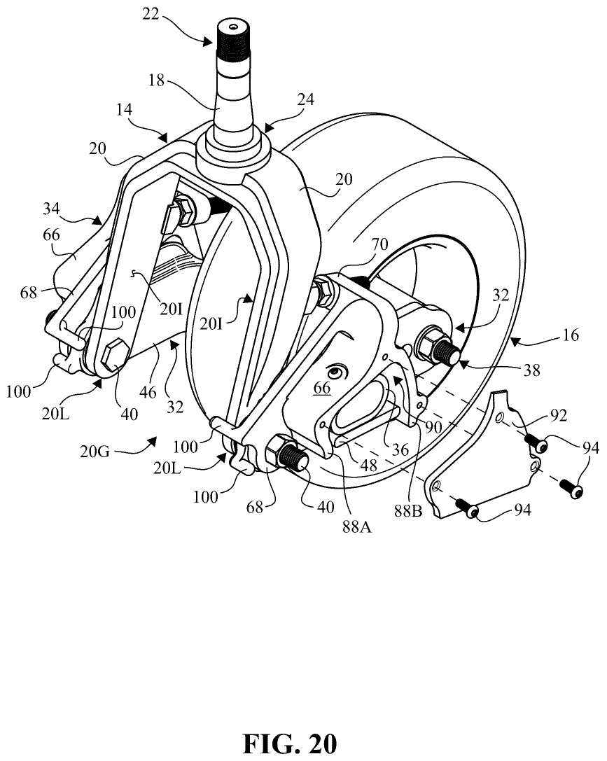

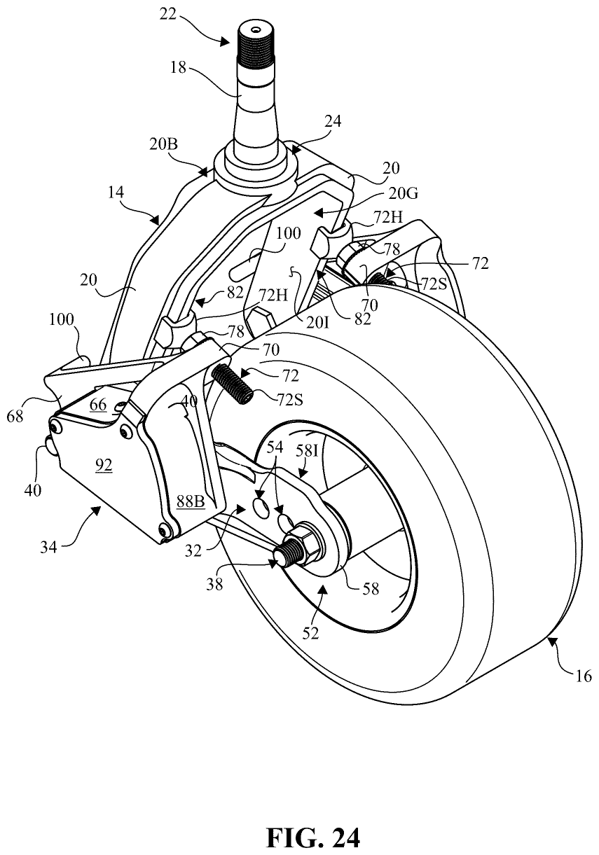

Preferably, as shown in FIGS. 3, 4, 20, and 24, the abutment arms 34 can further comprise a cover plate 92 which can be secured to the walls 66, 88a, 88b and encloses the spring pocket 90. The cover plate 92 can be secured to the walls 66, 88a, 88b by fasteners 94 such as, for example, bolts. In operation, the cover plate 92 is adapted to shield the spring member 36 and prevent debris from accumulating within the spring pocket 90 and obstructing the lower spring engaging shelf 48 from traversing therein.

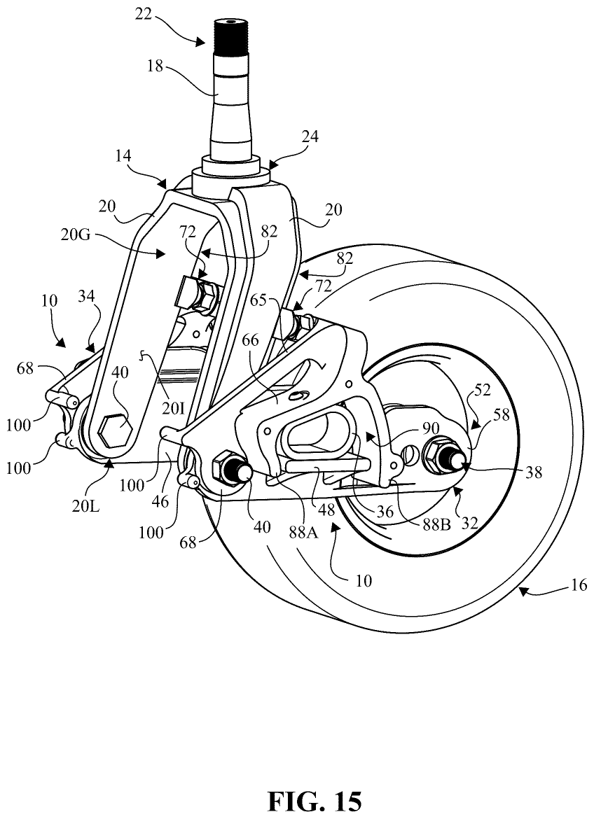

Preferably, the pivot and abutment arms 32, 34 each comprise a pivot stop tab 100. As shown in FIGS. 11A-B, 12-21, and 23, the pivot arm pivot stop tab 100 can extend/project from the pivot arm wall 46 away from the fork gap G and over the abutment arm mounting tab 68, and the abutment arm pivot stop tab 100 can extend from the mounting tab 68 towards the fork gap G and over the fork leg 20. In the event a wheel 16 loses contact with the ground and the suspension mechanisms 10 pivot downwardly away from the fork legs 20, such as, for example, if the wheel 16 falls into a rut or divot, the pivot stops 100 are adapted to prevent the suspension mechanisms 10 from rotating fully underneath the fork leg lower terminal ends 20L. For example, as best seen in FIG. 16, when the suspension mechanisms 10 rotate downwardly, the abutment arm pivot stop tab 100 engages the adjacent fork leg 20 and the pivot arm pivot stop tab 100 engages an adjacent abutment arm mounting tab 68 for thereby preventing the pivot and abutment arms 32, 34 from rotating fully beneath the fork leg lower terminal ends 20L.

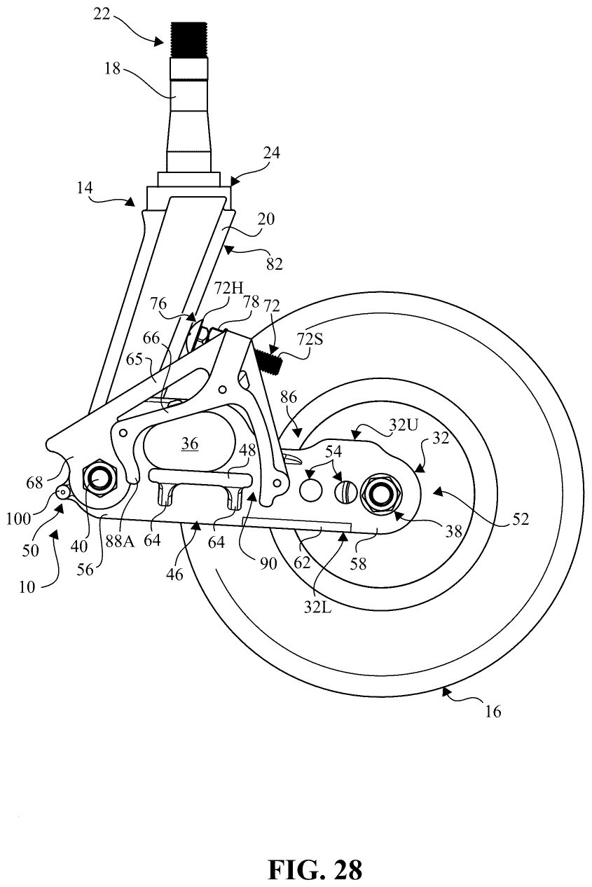

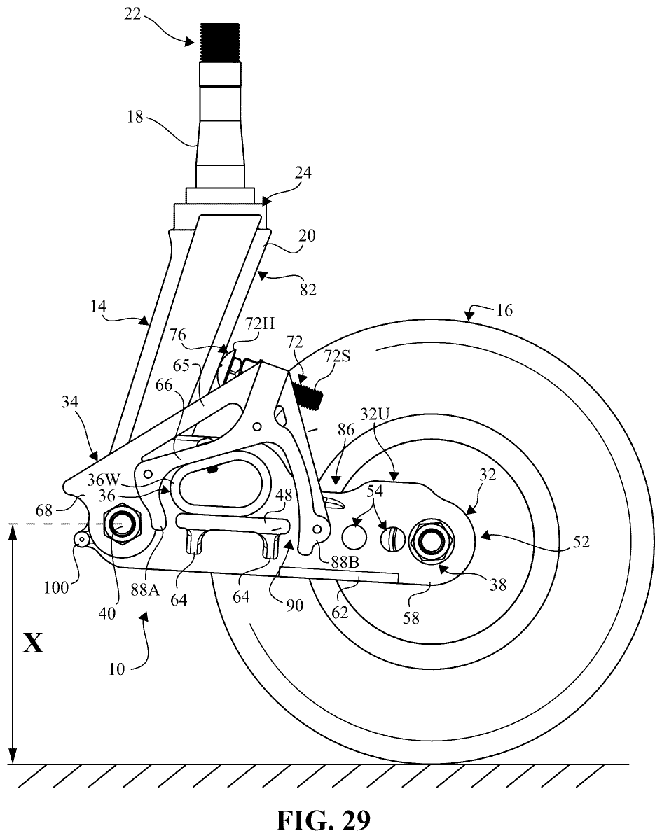

As mentioned above, the spring springs 36 are sandwiched between the pivot arms 32 and the abutment arms 34, and preferably between the pivot arm lower spring engaging shelves 48 and the abutment arm upper spring mounting walls 66. The springs 36 can be, for example, a coil spring (FIG. 27), a solid, elastically compressible polymer member (FIG. 28), a hollow, elastically compressible polymer member (FIGS. 8-10, 12, 13, 15-17, 19, 20, and 23), a combination of coil springs and elastically compressible polymer members, and/or other types of elastically compressible springs/dampers. Preferably, the springs 36 can be hollow cylinders comprising a flexible annular perimeter wall 36W. As the pivot arms 32 pivot upwardly towards the fork legs 20, the flexible annular perimeter walls 36W flex and the springs 36 compress and flatten for absorbing energy from the pivot arms 32 and thereby dampening/cushioning the energy transferred to the land vehicle/zero turn mower 12.

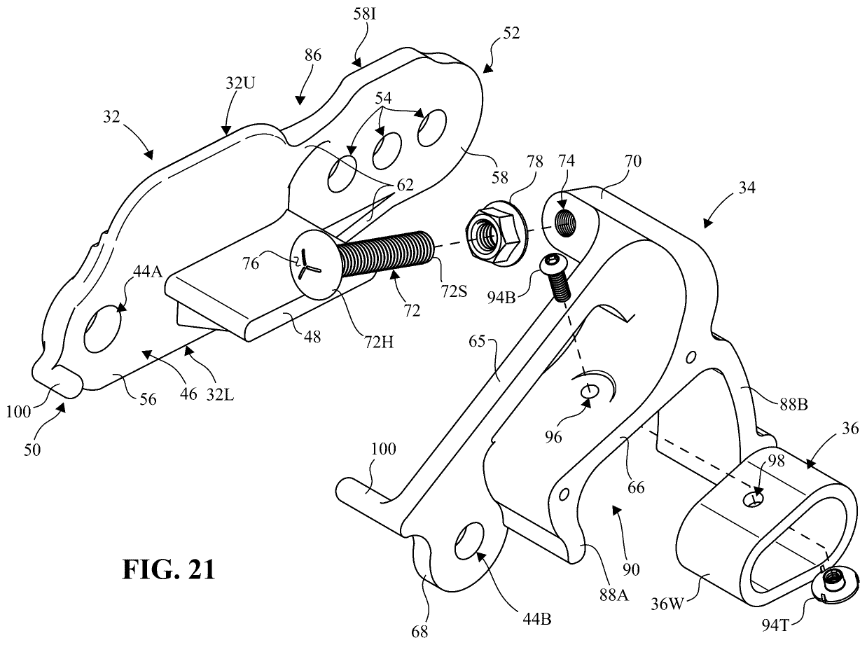

Preferably, the springs 36 are secured to the upper spring mounting walls 66. Yet more preferably, as best seen in FIG. 21, the springs 36 are secured to the upper spring mounting walls 66 with fasteners such as, for example, a bolt 94B and a T-nut 94T. In this regard, the upper spring mounting walls 66 can include a spring wall mounting bore 96 and the springs 36 can include a spring body bore 98 extending through the annular perimeter wall 36W. As best seen in FIGS. 7, 8, 21, and 23, the bolts 94B can be inserted through the spring mounting wall bores 96 and the spring body bores 98, and the T-nuts 94T can be threaded onto the bolts 94B, whereby the annular perimeter walls 36W are sandwiched and fastened between the upper spring mounting walls 66 and the T-nuts 94T.

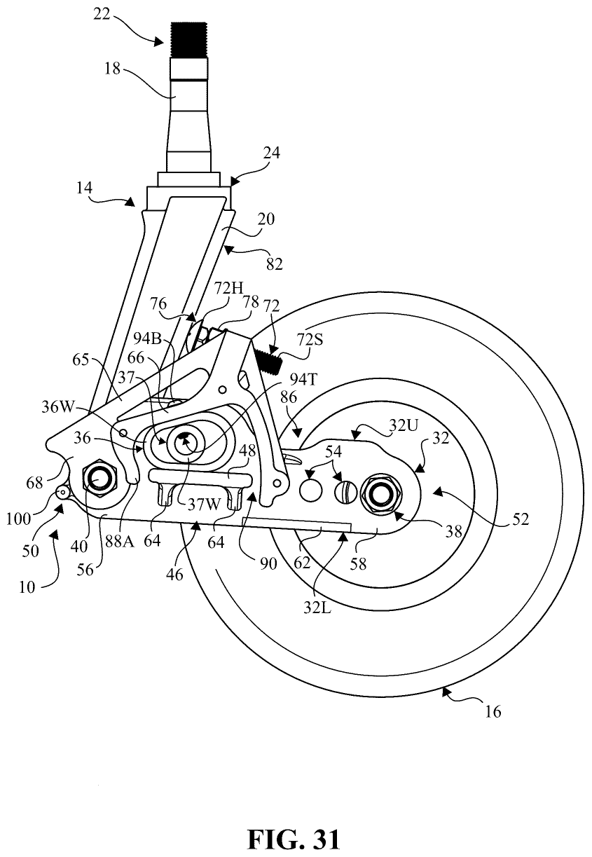

Referring now to FIG. 31, in another preferred embodiment, a second nested spring 37 is provided within the spring 36. Spring 37 can also be a coil spring or a solid elastically compressible polymer member similar to the springs 36 shown in FIGS. 27 and 28. Preferably, spring 37 is a hollow cylinder comprising a flexible annular perimeter wall 37W and, most preferably, as shown in FIG. 29, both springs 36 and 37 are hollow cylinders comprising a flexible annular perimeter wall. Also, both springs 36 and 37 are preferably secured to the upper spring mounting wall 66 with the bolt 94B and a T-nut 94T as shown. The second nested spring 37 provides a second stage of dampening for carrying heavier loads and varying the spring factor of the mechanism as needed or desired.

Preferably, the springs 36 and 37 are constructed from a resilient elastic polymer such as, for example, rubber, polyurethane, polybutadiene, neoprene, silicone, and other elastomers. Preferably, the springs 36 and 37 are formed by casting, molding, or otherwise forming or shaping from a unitary material.

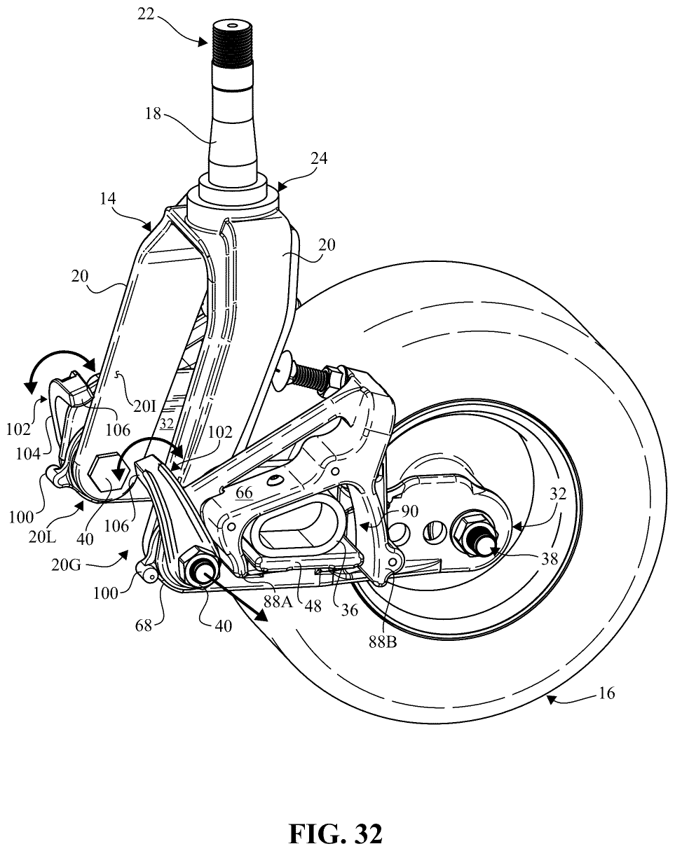

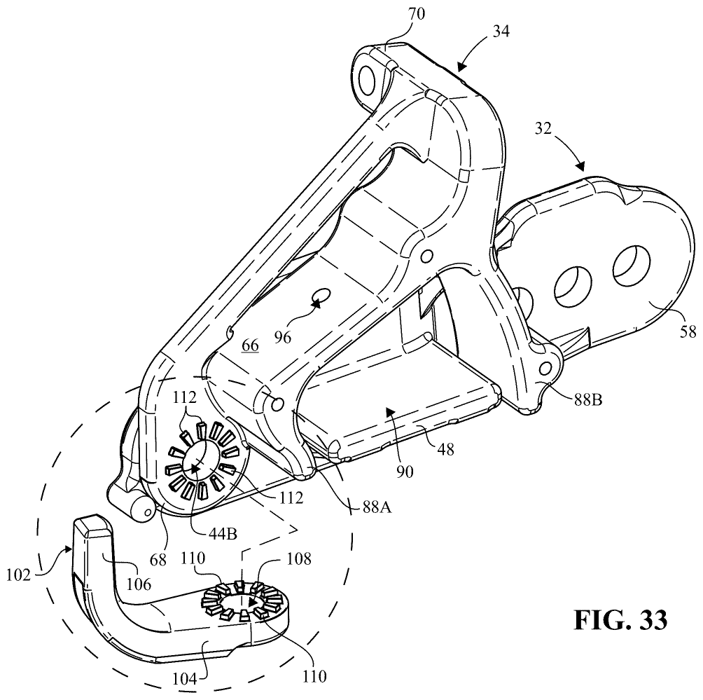

In another embodiment (FIGS. 32-34), the suspension mechanisms 10 include adjustable rotation limiting members 102 which function similar to and replace the pivot stop tabs 100 that are secured to or part of and extend from the mounting tab 68 of the abutment arms 34. That is, adjustable rotation limiting members 102 are adapted to prevent the suspension mechanisms 10 from rotating fully underneath the fork leg lower terminal ends 20L. The rotation limiting members 102 are L-shaped and include a mounting arm 104 which is configured to be mounted against/abutting the mounting tab 68 of the abutment arm 34 and an abutment finger 106 which extends perpendicularly from the mounting arm 104. The mounting arms 104 include a mounting arm bore 108 which is configured to receive the suspension pivot shaft 40 for mounting the rotation limiting members 102 to the pivot and abutment arms 32, 34 and the fork legs 20. The abutment fingers 106 extend perpendicularly from the mounting arms 104 towards the gap 20G over the pivot and abutment arms 32, 34 and the legs 20. In the event a wheel 16 loses contact with the ground and the suspension mechanisms 10 pivot downwardly away from the fork legs 20, such as, for example, if the wheel 16 falls into a rut or divot, the abutment fingers 106 are adapted to engage the fork legs 20 for preventing the suspension mechanisms 10 from rotating fully underneath the fork leg lower terminal ends 20L.

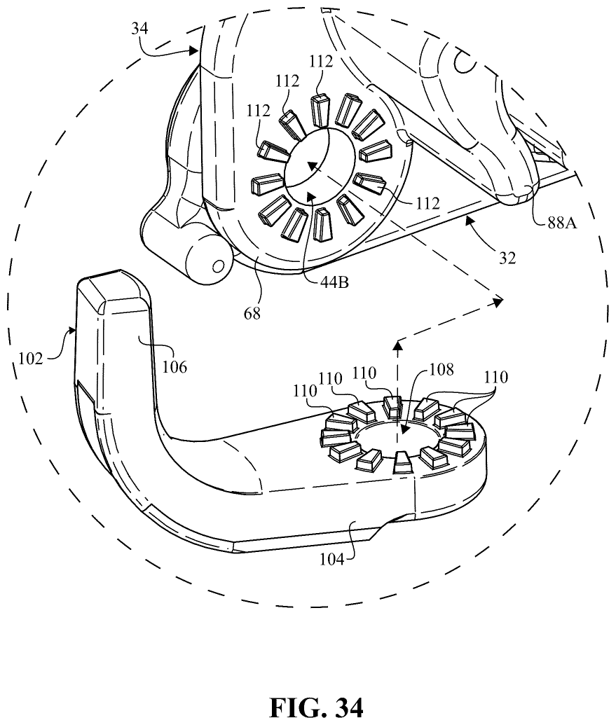

As best seen in FIG. 34, the mounting arms 104 also include a plurality of teeth 110 which protrude from the mounting arms 104 in a regularly-spaced circular pattern around the arm mounting bores 108. The mounting arm teeth 110 are configured to engage and interlock with a corresponding plurality of teeth 112 which protrude from the mounting tabs 68 in a circular pattern around the abutment arm mounting bore 44B. In use, the interlocking teeth 110, 112 prevent the mounting arms 104, and, hence, the rotation limiting members 102, from pivoting relative to the abutment arms 34. Specifically, when the mounting arms 104 are placed against/abutting the mounting tabs 68, the mounting arm teeth 110 are configured to slot into the spaces between the mounting tab teeth 112. If the mounting arms 104 begin to pivot relative to the mounting tabs 68, the mounting arm teeth 110 will engage the mounting tab teeth 112 for preventing the mounting arms 104 from continuing to pivot.

The interlocking teeth 110, 112 also allow the rotation limiting members 102 to be selectively rotated and repositioned to accommodate the geometries and structures of different models or types of forks 14. For example, the rotation limiting members 102 can be selectively rotated and repositioned by loosening the suspension pivot shafts 40, retracting the mounting arms 104 away from the mounting tabs 68 for disengaging the mounting arm teeth 110 from the mounting tab teeth 112, and rotating the rotation limiting members 102 towards or away from the fork legs 20 until the rotation limiting members 102 are in the desired position—e.g., the position whereat the abutment fingers 106 will engage the fork legs 20 before the suspension mechanisms 10 rotate fully underneath the fork leg lower terminal ends 20L. The rotation limiting members 102 are then locked in place by pressing the mounting arms 104 towards and against the mounting tabs 68 with the mounting arm teeth 110 interlocking between the mounting tab teeth 112 and then tightening the suspension pivot shafts 40 for securing the mounting arms 104 against the mounting tabs 68.

Preferably, except as otherwise set forth herein, the components of the suspension mechanisms 10 are integrally formed from a rigid, high-strength material such as, for example, steel, aluminum, ultra-high molecular weight polyethylene, high density polyethylene, or other high-strength metals or engineered polymers. Preferably, except as otherwise set forth herein, the components of the suspension mechanisms 10 are formed by casting, molding, machining, or otherwise shaping or forming from a unitary material.

While this invention has been described as having an exemplary design, the present invention may be further modified within the spirit and scope of this disclosure. This application is therefore intended to cover any variations, uses, or adaptations of the invention using its general principles.

What is claimed is:

1. A suspension mechanism adapted to be installed on a caster comprising a fork and a wheel, wherein the fork includes a pair or fork legs and the wheel is rotatably mounted on an axle coupled to the fork legs, wherein a suspension mechanism is installed between each of the fork legs and the wheel axle and each suspension mechanism comprises:
a pivot arm pivotally secured to and projecting from a fork leg, and coupled to the wheel axle;
an abutment arm pivotally secured to and projecting from the fork leg, and abutting the fork leg; and,
a spring between the pivot arm and the abutment arm which cushions impact forces experienced by the wheel and axle as they are transferred to the abutment arm the fork leg.

2. The suspension mechanism of claim 1 wherein the pivot arm and abutment arm pivot about a common axis.

3. The suspension mechanism of claim 1 wherein the pivot arm and abutment arm are pivotally secured to the fork leg at the location whereat the axle was coupled to the fork leg.

4. The suspension mechanism of claim 1 wherein the spring is an elastically compressible spring comprising a hollow elastically compressible polymer member, a hollow cylinder comprising a flexible annular perimeter wall, a solid elastically compressible polymer member, or a coil spring.

5. The suspension mechanism of claim 1 wherein each suspension mechanism further comprises a stopper secured to and adapted to retract or extend away from the abutment arm and abut the fork leg whereby the distance between the fork leg and abutment arm is selectively adjustable.

6. The suspension mechanism of claim 5 wherein the stopper comprises a semispherical head or a fork leg receiving channel abutting the fork leg.

7. The suspension mechanism of claim 1, wherein the pivot arm comprises a spring engaging shelf projecting therefrom and located between the pivot arm to fork leg pivotal connection and the pivot arm to wheel axle coupling, the abutment arm comprises a spring wall projecting therefrom, and the spring is sandwiched between the pivot arm spring engaging shelf and the abutment arm spring wall.

8. The suspension mechanism of claim 1, wherein a gap is defined between the fork legs and wherein the pivot arms and abutment arms are pivotally secured to the fork legs outside of the gap.

9. The suspension mechanism of claim 1 wherein the pivot arm and abutment arm are pivotally secured to the fork leg at the location whereat the axle was coupled to the fork leg on a suspension shaft, and wherein the pivot and abutment arms pivot independently from, and slide past, each other like scissor blades.

10. The suspension mechanism of claim 1, wherein pivot arms comprise a plurality of wheel axle bores spaced at different distances from the pivot arm to fork leg pivotal connection, whereby the wheel axle can be coupled to the pivot arm at different distances from the pivot arm to fork pivotal connection.

11. The suspension mechanism of claim 1 wherein the caster is pivotally secured to a zero turn mower and is adapted to pivot about a vertical axis.

12. The suspension mechanism of claim 1 wherein the pivot arm comprises a pivot stop tab adapted to engage the abutment arm and limit the rotational travel of the pivot arm, and the abutment arm comprises a pivot stop tab adapted to engage the fork leg and limit the rotational travel of the abutment arm.

13. The suspension mechanism of claim 1 wherein a second spring is nested within the spring located between the pivot arm and the abutment arm.

14. A caster assembly comprising:
a fork;
a wheel; and,
a suspension mechanism comprising:
a pivot arm pivotally secured to the fork and projecting therefrom;
wherein the wheel is rotatably secured to the pivot arm;
an abutment arm pivotally secured to the fork and projecting therefrom, and abutting the fork;
a spring between the pivot arm and the abutment arm; and,
wherein impact forces experienced by the wheel are cushioned by the spring as they transferred to the abutment arm and to the fork.

15. The caster assembly of claim 14 wherein the pivot arm and abutment arm pivot about a common axis.

16. The caster assembly of claim 14 wherein the spring is an elastically compressible spring comprising a hollow elastically compressible polymer member, a hollow cylinder comprising a flexible annular perimeter wall, a solid elastically compressible polymer member, or a coil spring.

17. The caster assembly of claim 14 wherein the suspension mechanism further comprises a stopper secured to and adapted to retract or extend away from the abutment arm and abut the fork whereby the distance between the fork and abutment arm is selectively adjustable.

18. The caster assembly of claim 17 wherein the fork comprises a fork leg and the stopper comprises a semispherical head or a fork leg receiving channel abutting the fork leg.

19. The caster assembly of claim 14, wherein the pivot arm comprises a spring engaging shelf projecting therefrom and located between the pivot arm to fork leg pivotal connection and the pivot arm to wheel rotatable securement, and the abutment arm comprises a spring wall projecting therefrom, and the spring is sandwiched between the pivot arm spring engaging shelf and the abutment arm spring wall.

20. The caster assembly of claim 14, wherein the fork comprises a pair of fork leg defining a gap therebetween and wherein the pivot arms and abutment arms are pivotally secured to the fork legs outside of the gap.

21. The caster assembly of claim 14 wherein the caster is pivotally secured to a zero turn mower and is adapted to pivot about a vertical axis.

22. The suspension mechanism of claim 14 wherein the pivot arm comprises a pivot stop tab adapted to engage the abutment arm and limit the rotational travel of the pivot arm, and the abutment arm comprises a pivot stop tab adapted to engage the fork and limit the rotational travel of the abutment arm.

23. The suspension mechanism of claim 14 wherein a second spring is nested within the spring located between the pivot arm and the abutment arm.

24. A method of converting a caster comprising a fork and a wheel into a spring loaded caster, wherein the fork comprises a pair of fork legs and the wheel is rotatably mounted on an axle coupled to the fork legs, by installing a suspension mechanism between each fork leg and the axle, wherein each suspension mechanism comprises a pivot arm, an abutment arm and an elastically compressible spring, the method comprising the steps of:
uncoupling the wheel axle from the fork legs;
pivotably securing a pivot arm and an abutment arm to each of the fork legs, wherein the abutment arms abut the fork legs;
sandwiching an elastically compressible spring between each of the pivot arms and the abutment arms; and,
coupling the wheel axle to the pivot arms for rotatably securing the wheel thereto.

25. The method of claim 24 wherein during the step of pivotably securing, the pivot arm and the abutment arm are secured to each of the fork legs at the location whereat the axle was coupled to the fork leg.

26. The method of claim 24 wherein each abutment arm comprises a stopper secured to and adapted to retract or extend away from the abutment arm towards the fork leg and wherein the method further comprises the step of retracting or extending the stopper from the abutment arm and adjusting the distance between the fork leg and the abutment arm.

27. The method of claim 24 wherein a gap is defined between the fork legs and wherein, during the step of pivotally securing, the pivot arms and abutment arms are pivotally secured to the fork legs outside of the gap.

28. A method of converting a caster comprising a fork and a wheel into a spring loaded caster comprising the steps of:
uncoupling the wheel from the fork;
pivotally securing a pivot arm to the fork, wherein the pivot arm projects away from the fork;
pivotally securing an abutment arm to the fork, wherein the abutment arm projects away from the fork and abuts the fork;
providing an elastically compressible spring between the pivot arm and the abutment arm; and,
rotatably securing the wheel to pivot arm.

29. The method of claim 28 wherein during the steps of pivotably securing, the pivot arm and the abutment arm are secured to the fork legs at the location whereat the wheel was coupled to the fork.

30. The method of claim 28 wherein the abutment arm comprises a stopper secured to and adapted to retract or extend away from the abutment arm towards the fork and wherein the method further comprises the step of retracting or extending the stopper from the abutment arm and adjusting the distance between the fork and the abutment arm.

31. The suspension mechanism of claim 1 further comprising an L-shaped rotation limiting member, wherein the rotation limiting member is secured to the abutment arm and abuts against the fork leg for preventing the suspension mechanism from pivoting underneath the fork legs.

32. The suspension mechanism of claim 31, wherein the rotation limiting member comprises a mounting arm and an abutment finger extending perpendicularly from the mounting arm, wherein the mounting arm is secured to the abutment arm, and wherein the abutment finger extends over and engages the fork leg.

33. The suspension mechanism of claim 32, wherein the mounting arm includes a first plurality of teeth and the abutment arm includes a second plurality of teeth, and wherein the first and second pluralities of teeth interlock with and engage each other for preventing the rotation limiting member from pivoting relative to the abutment arm.
